(19) United States
(12) Patent Application Publication
(10) Pub. No.: US 2021/0206999 A1
(43) Pub. Date: Jul. 8, 2021

(54) BULK SUPERHYDROPHOBIC COMPOSITIONS

(71) Applicant: NITTO DENKO CORPORATION, Osaka (JP)

(72) Inventors: Kaoru Ueno, Escondido, CA (US); Guang Pan, Carlsbad, CA (US)

(21) Appl. No.: 16/492,710

(22) PCT Filed: Mar. 16, 2018
(86) PCT No.: PCT/US2018/022937

§ 371 Date: Sep. 10, 2019

Related U.S. Application Data
(60) Provisional application No. 62/472,949, filed on Mar. 17, 2017.
(60) Provisional application No. 62/527,676, filed on Jun. 30, 2017.

(51) Int. Cl. C09D 183/04; C09D 5/00; C09D 7/61; C09D 7/40; C09D 7/65

(52) U.S. Cl. CPC C09D 183/04; C09D 5/00; C09D 7/61; C09D 7/67; C08K 3/36; C09D 7/68; C09D 7/65; C09D 7/70; C09D 7/69

(57) ABSTRACT

Described herein are superhydrophobic coatings based on silica nanoparticles, metal compound nanoparticles, and hydrophobic polymers that provide a damage tolerant superhydrophobic capability, wherein the metal compound nanorods can comprise a rare earth metal phosphate salt or an aluminum oxide. Methods of creating water resistant materials by employing the aforementioned coatings are also described.

### FIELD

The present embodiments are related to bulk superhydrophobic compositions, including coatings of said compositions for uses such as water, ice, and snow repellents.

### BACKGROUND

In the many applications the buildup of water, ice, and snow can create undesirable results. These issues can include fogging of glasses, corrosion due to water intrusion, loss of visibility due to water buildup, and ice buildup. On windshields of motor craft such as automobiles, boats, and aircraft, complex systems are designed to remove water which include wipers, air jets, and passive systems such as deflectors. On wings of airplanes and rotor blades of helicopters, the buildup of ice on the leading edges and on the upper wing surfaces can create hazardous conditions by changing the shape of the wing and/or increasing the total weight, resulting in stall or loss of performance. In addition, deposited ice can suddenly dislodge resulting in a sudden change in characteristics and possibly loss of control. To combat icing on aircraft during takeoff many airports use anti-icing fluid such as propylene glycol or more toxic counterparts, however airports must employ recovery systems to catch the runoff or face adverse environmental impacts. Due to the concerns and cost of glycol, some airports have opted for the use of infrared based heating of aircraft before taking off which allows for the reduction in the use of glycol, some constructing aircraft-sized heating lamp hangars. At flight, aircraft use bleed air, pneumatic expanders, or heating elements to shed accumulated ice, all which have operational limits or which affect the efficiency of the aircraft.

While there have been other nanoparticle based hydrophobic coatings, such as those based on TiO₂ nanoparticles, such coatings are prone to cracking. It is believed that the susceptibility to cracking is due to the small size of the particles which attributes to their inability of the composite to carry shearing and bending stresses. In addition it is known in the art that rare earth metals oxides are intrinsically hydrophobic but they can be hydrolyzed and are potentially unstable. As a result, there is a continuing need for passive superhydrophobic coatings that will allow for easier repulsion of ice and water.

### SUMMARY

Some embodiments include a superhydrophobic composition comprising: a hydrophobic polymer; silica nanoparticles; and metal compound nanoparticles; wherein the composite has bulk superhydrophobic properties.

Some embodiments include a method of surface treatment comprising applying a superhydrophobic composition described herein to a surface in need of treatment.

Some embodiments include a device, such as a vehicle (e.g. an aircraft or an automobile), comprising a surface which is at least partially covered with a superhydrophobic composition described herein.

Some embodiments include fabric which is at least partially covered or coated with a superhydrophobic composition described herein.

### BRIEF DESCRIPTION OF THE DRAWINGS

FIG. 1 is a depiction of a possible embodiment of a method of treating a surface to become a superhydrophobic by applying a superhydrophobic coating to the untreated surface.

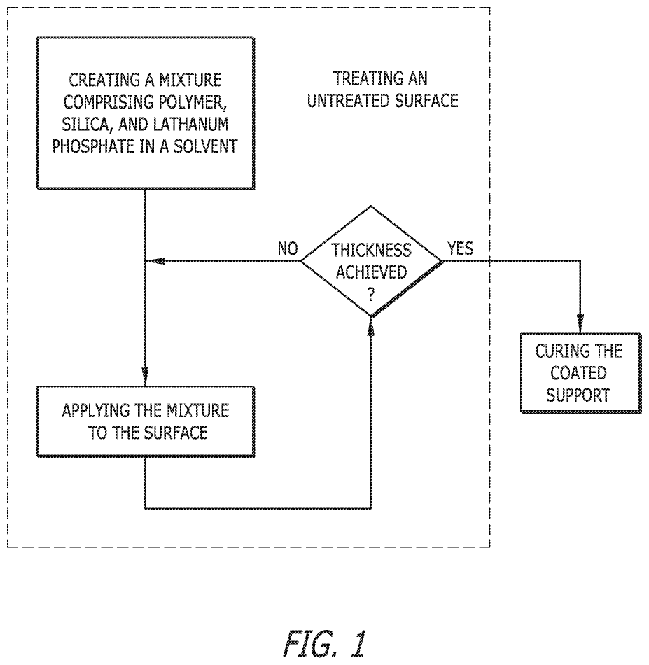

FIG. 2 is a picture showing a comparison of a possible embodiment with lanthanum phosphate nanorods and a comparative embodiment using titanium dioxide nanoparticles instead of the lanthanum phosphate nanorods. Transmission Electron Microscope insets show relative sizes of lanthanum phosphate nanorods and titanium dioxide nanoparticles.

FIG. 3 is a plot showing the performance between one embodiment and a comparative example when exposed to fine abrasion conditions, e.g., worn by cotton.

### DETAILED DESCRIPTION

The present disclosure relates to superhydrophobic compositions that can be useful as coatings in self-cleaning applications and in water, ice, or snow repellent applications. Compositions that are designated as “superhydrophobic” include a compositions that are highly hydrophobic, or repel water. The tendency to repel water may be measured by the contact angle of a water droplet with the surface, where if the contact angle with the surface is at least 150° it is said to be superhydrophobic.

Some of the compositions described herein can be superhydrophobic throughout the composition, or a bulk superhydrophobic property (or superhydrophobicity), instead of only on the surface. This may provide the advantage that, if the surface is eroded or ablated, the remaining surface retains its superhydrophobicity. Thus, some superhydrophobic compositions described herein are damage tolerant such that the superhydrophobic properties are retained after being eroded. Thus, some superhydrophobic compositions described herein maintain their hydrophobic or superhydrophobic properties for longer periods of time, and/or are more durable.

One way to determine whether a composition has bulk superhydrophobicity is by removing the surface and some amount of the underlying material by abrasion, and measuring the contact angle after abrasion. For example, the contact angle may be measure after 5-8 μm, 5-6 μm, 5 μm, 6 μm, 6-7 μm, 7 μm, 7-8 μm, or 8 μm of the material from the surface has been removed by abrasion. In some embodiments, the composition retains or gains its superhydrophobic properties (e.g., contact angle) after abrasion.

In some embodiments, the superhydrophobic composition can be in the form of a coating. In some embodiments, the coating can have a thickness in a range of about 10 μm to about 1000 μm, or about 30 μm, about 46 μm, about 79 μm, about 106 μm.

In terms of the chemical makeup of the superhydrophobic composition, generally, the superhydrophobic composition comprises a hydrophobic polymer, silica nanoparticles, and metal composite nanoparticles, such as nanorods. The superhydrophobic composition may also contain other components, such as particle additives.

The superhydrophobic composition may be in any suitable form, such as a solid, e.g. a composite solid or a homogeneous solid. For example, various components of the hydrophobic composition can be mixed such that they form a substantially uniform mixture. For example, the individual localized mass ratio of a specific constituent to the total composite may vary less than 30% from the average mass ratio for that constituent. Some of the components of the superhydrophobic composition can be crosslinked, and may, for example, form a material matrix. In some embodiments, some of the materials can be loaded into the material matrix.

Any suitable hydrophobic polymer may be used in a superhydrophobic composition, examples include a silicon-containing or a silicon-based polymer, such as a silane, a polyalkylsiloxane, such as polydimethylsiloxane (or a silicone); polymer having a carbonyl functional group, such as an amide, an ester, a carbamate, or a carbonate, repeating unit in the backbone such as a polycarbonate; a polymer having an all-carbon backbone such as a polyalkylene, an acrylate (such as poly n-butylmethacrylate), a polystyrene, etc.; a polyfluorocarbon; etc. In some embodiments, the hydrophobic polymer comprises, or consists of, polydimethylsiloxane. In some embodiments, the hydrophobic polymer comprises, or consists of, a polycarbonate.

In some embodiments, the hydrophobic polymer comprises, or consists of, a combination or mixture of polycarbonate and polydimethylsiloxane. In these embodiments, the mass ratio of polydimethylsiloxane to polycarbonate can be in a range from about 0.1-0.3 (1 g of polydimethylsiloxane and 10 grams of polycarbonate is a mass ratio of 0.1), about 0.2-0.4, about 0.3-0.5, about 0.4-0.6, about 0.5-0.7, about 0.1-0.5, about 0.6-0.8, about 0.7-0.9, about 0.8-1, about 0.5-1, about 0.8-1.2, about 1-1.4, about 1.2-1.6, about 1.4-1.8, about 1.6-2, about 1-2, about 2-3, about 3-4, about 4-5, about 2-5, about 5-6, about 6-7, about 7-8, about 8-9, about 9-10, or about 5-10, or any mass ratio in a range bounded by any of these values.

In some embodiments, the polyalkylsiloxane, such as polydimethylsiloxane, can be about 0.1-10 wt %, about 2-5 wt %, about 4-7 wt %, about 6-9 wt %, about 8-11 wt %, about 10-13 wt %, about 12-15 wt %, about 14-17 wt %, about 16-19 wt %, about 18-21 wt %, about 20-23 wt %, about 10-20 wt %, about 22-25 wt %, about 24-27 wt %, about 26-29 wt %, about 28-31 wt %, about 20-30 wt %, about 0.1-30 wt %, about 30-40 wt %, about 40-50 wt %, about 50-60 wt %, about 30-60 wt %, about 60-70 wt %, about 70-80 wt %, about 80-90 wt %, about 60-90 wt %, or about 90-100 wt % of the total superhydrophobic composition, or any wt % in a range bounded by any of these values. Of particular interest are ranges that encompass one or more of the following weight percentages: about 8 wt %, about 9 wt %, about 10 wt %, about 12 wt %, about 13 wt %, about 21 wt %, and about 30.

In some embodiments, the polycarbonate can be about 0.1-10 wt %, about 10-20 wt %, about 20-30 wt %, 20-26 wt %, 24-30 wt %, 20-25 wt %, 25-30 wt %, about 9-14 wt %, about 12-17 wt %, about 15-20 wt %, about 18-23 wt %, about 20-23 wt %, about 22-25 wt %, about 24-27 wt %, about 26-29 wt %, about 28-31 wt %, about 30-33 wt %, about 30-35 wt %, about 33-38 wt %, about 36-41 wt %, about 39-44 wt %, about 42-47 wt %, about 45-50 wt %, about 48-53 wt %, about 0.1-30 wt %, about 30-40 wt %, about 40-50 wt %, about 50-60 wt %, about 30-60 wt %, about 60-70 wt %, about 70-80 wt %, about 80-90 wt %, about 60-90 wt %, or about 90-100 wt % of the total superhydrophobic composition, or any wt % in a range bounded by any of these values. Of particular interest are ranges that encompass one or more of the following weight percentages: about 12 wt %, about 21 wt %, about 24 wt %, about 26 wt %, about 28 wt %, about 29 wt %, about 30 wt %, about 33 wt %, about 39 wt %, about 45 wt %, and about 46 wt %.

In some embodiments, the hydrophobic polymer may contain polystyrene in any suitable amount, such as about 1-50 wt %, 10-50 wt %, 25-40 wt %, about 24-29 wt %, about 27-32 wt %, about 30-35 wt %, about 33-38 wt %, about 36-41 wt %, or about 39-44 wt % of the total superhydrophobic composition, or any wt % in a range bounded by any of these values. Of particular interest are ranges that encompass one or more of the following weight percentages: about 29 wt %, about 38 wt %, and about 39 wt %.

In some embodiments, the hydrophobic polymer may contain poly n-butylmethacrylate in any suitable amount, such as about 1-50 wt %, 10-50 wt %, 25-40 wt %, about 24-29 wt %, about 27-32 wt %, about 30-35 wt %, about 33-38 wt %, about 36-41 wt %, or about 39-44 wt % of the total superhydrophobic composition, or any wt % in a range bounded by any of these values. Of particular interest are ranges that encompass one or more of the following weight percentages: about 29 wt %, about 31 wt %, about 35 wt %, about 38 wt %, and about 41 wt %.

### Silica Nanoparticles

A silica nanoparticle may be any nanoparticle that comprises silica or silicon dioxide, such as a SiO₂ particle, e.g. a sphere, or a glass particle, e.g. a sphere. The nanoparticles may be essentially pure silica nanoparticles, or may contain at least about 0.1 wt %, at least about 10 wt %, at least about 20 wt %, at least about 30 wt %, at least about 40 wt %, at least about 50 wt %, at least about 60 wt %, at least about 70 wt %, at least about 80 wt %, at least about 90, about 0.1-10 wt %, about 10-20 wt %, about 20-30 wt %, about 30-40 wt %, about 40-50 wt %, about 50-60 wt %, about 60-70 wt %, about 70-80 wt %, about 80-90 wt %, or about 90-100 wt % silicon dioxide or silica.

A silica nanoparticle may have any size associated with a nanoparticle. For example, a silica nanoparticle may have a size, average size, or median size, such as a radius or a diameter, of the particle that is about 0.5-1000 nm, about 20 nm, about 0.1-10 nm, about 10-20 nm, about 10-30 nm, about 20-30 nm, about 30-40 nm, about 40-50 nm, about 50-60 nm, about 60-70 nm, about 70-80 nm, about 80-90 nm, about 90-100 nm, about 0.1-100 nm, about 100-110 nm, about 100-200 nm, about 150-250 nm, about 200-300 nm, about 250-350 nm, about 300-400 nm, about 350-450 nm, about 400-500 nm, about 450-550 nm, about 500-600 nm, about 0.1-600 nm, about 550-650 nm, about 600-700 nm, about 650-750 nm, about 700-800 nm, about 750-850 nm, about 800-900 nm, about 850-950 nm, about 900-1000 nm, or any size, such as a radius, a diameter, in a range bounded by any of these values.

As used herein, the terms “radius” or “diameter” can be applied to particles that are not spherical or cylindrical. For elongated particles, where the aspect ratio or the ratio of length to width is important, the “radius” or “diameter” is the radius or diameter of a cylinder having the same length and volume as the particle. For non-elongated particles, the “radius” or “diameter” is the radius or diameter of a sphere having the same volume as the particle.

Any suitable amount of the silica nanoparticle may be used. In some embodiments, the silica nanoparticle may (e.g. SiO₂ nanoparticles) be about 0.1-10 wt %, about 10-20 wt %, about 20-30 wt %, about 30-40 wt %, about 40-50 wt %, about 50-60 wt %, about 60-70 wt %, about 70-80 wt %, about 80-90 wt %, or about 90-100 wt %, about 20-35 wt %, about 22-35 wt %, about 26-35 wt %, about 30-35 wt %, 22-30 wt %, about 10-13 wt %, about 12-15 wt %, about 14-17 wt %, about 16-19 wt %, about 18-21 wt %, about 20-23 wt %, about 22-25 wt %, about 24-27 wt %, about 26-29 wt %, about 28-31 wt %, about 30-33 wt %, about 32-35 wt %, about 34-37 wt %, about 36-39 wt %, about 38-41 wt %, about 40-43 wt %, about 22-43 wt %, about 42-45 wt %, about 44-47 wt %, about 46-49 wt %, about 48-51 wt %, about 50-53 wt %, about 52-55 wt %, about 34-55 wt %, about 56-59 wt %, about 58-61 wt %, of the superhydrophobic composition, or any weight percentage in a range bounded by any of these values. Of particular interest are ranges that encompass one or more of the following weight percentages: about 13 wt %, about 15 wt %, about 19 wt %, about 20 wt %, about 21 wt %, about 23 wt %, about 26 wt %, about 29 wt %, about 30 wt %, about 34 wt %, about 38 wt %, about 39 wt %, about 44 wt %, about 45 wt %, about 54 wt %, or about 59 wt %

In some embodiments, the silica nanoparticles can be modified, e.g. chemically modified. For example, the one or more chemical compounds can be covalently bonded to the surface of the silica nanoparticles. In some embodiments, silica nanoparticles are fluorinated, or the nanoparticles can be fluorinated silicon oxide. In some embodiments, the fluorinated silicon oxide can be about 0.1-10 wt %, about 10-20 wt %, about 20-30 wt %, about 30-40 wt %, about 40-50 wt %, about 50-60 wt %, about 60-70 wt %, about 70-80 wt %, about 80-90 wt %, or about 90-100 wt %, about 20-35 wt %, about 22-35 wt %, about 26-35 wt %, about 30-35 wt %, or 22-30 wt %, of the superhydrophobic composition, or any weight percentage in a range bounded by any of these values.

A superhydrophobic composition may comprise any suitable metal compound nanoparticles, such as nanorods or nanowires. In some superhydrophobic compositions, the metal compound nanorods or nanowires comprise, or consist of, a phosphate salt of a rare earth metal (such as lanthanum) or a metal oxide (such as an aluminum oxide).

In some embodiments, the metal compound nanoparticles, such as aluminum oxide nanorods or nanowires, can include, or be covalently or noncovalently bound to, an optionally substituted C₁₄₋₂₀ linear or branched carboxylic acid, such as an optionally substituted fatty acid. Examples may include optionally substituted C₁₄ carboxylic acids (including C₁₄ fatty acids), optionally substituted C₁₅ carboxylic acids, optionally substituted C₁₆ carboxylic acids (including C₁₆ fatty acids), optionally substituted C₁₇ carboxylic acids, optionally substituted C₁₈ carboxylic acids (such as C₁₈ fatty acids, e.g. stearic acid, isostearic acid, etc.), optionally substituted Cig carboxylic acids, or optionally substituted C₂₀ carboxylic acids (such as C₂₀ fatty acids). In some embodiments, the linear or branched carboxylic acid is isostearic acid.

Some aluminum oxide nanorods may be modified by reaction with the carboxylic acid, such as a fatty acid (e.g. isostearic acid). It is believed that surface modification of the metal oxide can make it more resistant to hydrolysis and/or more hydrophobic than a non-modified oxide. The reaction is represented below:

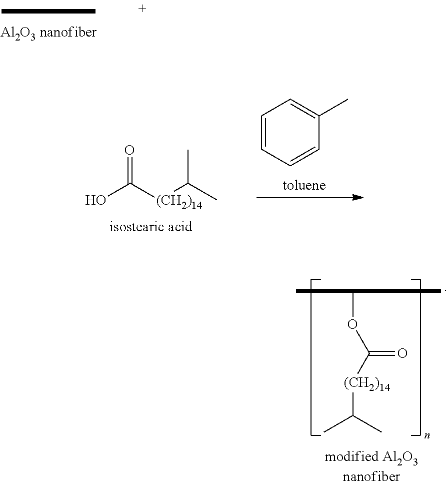

In some embodiments, the nanorods or nanowires comprise, or consist of, a lanthanum (III) phosphate, or LaPO₄. It is believed that a rare-earth phosphate may be more resistant to hydrolysis than the corresponding rare-earth oxide. It is believed that the hydrophobic materials in the superhydrophobic composition can coat metal compound nanorods or nanowires to increase the hydrophobicity of the metal compound nanorods or nanowires.

A nanorod or a nanowire may be an elongated nanoparticle. For example, a nanorod or a nanowire, such as a lanthanum (III) phosphate or an aluminum (III) oxide (including carboxylic acid modified aluminum (III) oxide) nanorods or nanowires, may have an aspect ratio (i.e., length/width or length/diameter) of about 5 to about 10,000, about 5-10, about 5-25, about 10-30, about 15-35, about 20-40, about 25-45, about 30-50, about 35-55, about 40-60, about 45-65, about 50-70, about 55-75, about 60-80, about 65-85, about 70-90, about 75-95, about 80-100, about 50-150, about 100-200, about 150-250, about 200-300, about 250-350, about 300-400, about 350-450, about 400-,500, about 450-550, about, 500-600, about 550-650, about 600-700, about 650-750, about 700-800, about 750-850, about 800-900, about 850-950, about 900-1,000, about, 500-1,500, about 1,000-2,000, about 1,500-2,500, about 2,000-3,000, about 2,500-3,500, about 3,000-4,000, about 3,500-4,500, about 4,000-5,000, about 4,500-5,500, about 5,000-6,000, about 5,500-6,500, about 6,000-7,000, about 6,500-7,500, about 7,000-8,000, about 7,500-8,500, about 8,000-9,000, about 8,500-9,500, about 9,000-10,000, over about 10,000, about 10, about 50, about 500, about 333, or about 5000, or any aspect ratio in a range bounded by any of these values.

It is believed that the larger sized, or more elongated or longer, nanoparticles may result in a composite that is less prone to cracking due to the ability of the individual nanoparticles to be able to carry external forces. In some embodiments, the nanorods or nanowires, such as a lanthanum (III) phosphate or an aluminum (III) oxide (including carboxylic acid modified aluminum (III) oxide) nanorods or nanowires, can have a length, such as an average or median length, in a range of about 0.1-3 μm, about 1-4 μm, about 2-5 μm, about 3-6 μm, about 4-7 μm, about 5-8 μm, about 6-9 μm, about 7-10 μm, about 0.1-20 μm, about 5-10 μm, about 10-15 μm, about 15-20 μm, about 20-25 μm, about 25-30 μm, about 30-35 μm, about 35-40 μm, about 40-45 μm, about 45-50 μm, about 50-55 μm, about 0.1-55 μm, about 55-60 μm, about 60-65 μm, about 65-70 μm, about 70-75 μm, about 75-80 μm, about 80-85 μm, about 85-90 μm, about 90-95 μm, about 95-100 μm, about 100-105 μm, about 55-105 μm, about 105-110 μm, about 110-115 μm, about 115-120 μm, about 120-125 μm, about 125-130 μm, about 130-135 μm, about 135-140 μm, about 140-145 μm, about 145-150 μm, about 150-155 μm, about 105-155 μm, about 155-160 μm, about 160-165 μm, about 165-170 μm, about 170-175 μm, about 175-180 μm, about 180-185 μm, about 185-190 μm, about 190-195 μm, about 195-200 μm, about 0.1-150 μm, about 0.1-5 μm, about 10-150 μm, about 0.1-2.5 μm, about 80-120 μm, or about 100 μm. In some embodiments, lanthanum (III) phosphate nanorods or nanowires have a length in a range of about 0.1-5 μm, or in a similar or an overlapping range identified above. In some embodiments, aluminum (III) oxide nanorods or nanowires, such as carboxylic acid modified aluminum (III) oxide nanorods or nanowires, have a length in a range of about 10-150 μm, or in a similar or an overlapping range identified above.

In some embodiments, the nanorods or nanowires, such as a lanthanum (III) phosphate or an aluminum (III) oxide (including carboxylic acid modified aluminum (III) oxide) nanorods or nanowires, can have an average or median width or a diameter of about 0.1-20 nm, about 2-7 nm, about 5-10 nm, about 10-15 nm, about 15-20 nm, about 20-25 nm, about 25-30 nm, about 30-35 nm, about 35-40 nm, about 40-45 nm, about 45-50 nm, about 50-55 nm, about 0.1-55 nm, about 55-60 nm, about 60-65 nm, about 65-70 nm, about 70-75 nm, about 75-80 nm, about 80-85 nm, about 85-90 nm, about 90-95 nm, about 95-100 nm, about 100-105 nm, about 55-105 nm, about 105-110 nm, about 110-115 nm, about 115-120 nm, about 120-125 nm, about 125-130 nm, about 130-135 nm, about 135-140 nm, about 140-145 nm, about 145-150 nm, about 150-155 nm, about 105-155 nm, about 155-160 nm, about 160-165 nm, about 165-170 nm, about 170-175 nm, about 175-180 nm, about 180-185 nm, about 185-190 nm, about 190-195 nm, about 195-200 nm, about 2-100 nm, about 2-30 nm, about 10-100 nm, about 40 nm, or about 20 nm, or any width or diameter in a range bounded by any of these values. In some embodiments, lanthanum (III) phosphate nanorods or nanowires have a width or diameter in a range of 10-100 nm, or in a similar or an overlapping range identified above. In some embodiments, aluminum (III) oxide nanorods or nanowires, such as carboxylic acid modified aluminum (III) oxide nanorods or nanowires, have a width or diameter, such as an average or median width or diameter, of 2-30 nm, or in a similar or an overlapping range identified above.

In some embodiments, lanthanum (III) phosphate nanorods have a length, such as an average or median length, in a range of 0.1-5 μm, or in a similar or an overlapping range identified above, and a width or diameter, such as an average or median width or diameter, in a range of 10-100 nm, or in a similar or an overlapping range identified above.

In some embodiments, aluminum (III) oxide nanorods, such as carboxylic acid modified aluminum (III) oxide nanorods, have a length, such as an average or median length, in a range of 10-150 μm, or in a similar or an overlapping range identified above, and a width or diameter, such as an average or median width or diameter, in a range of 2-30 nm, or in a similar or an overlapping range identified above.

The metal compound nanoparticles, such as nanorods or nanowires, can be present in any suitable amount in a superhydrophobic composition. For example, a nanorod or nanowire may be about 0.1-10 wt %, about 10-20 wt %, about 10-13 wt %, about 12-15 wt %, about 14-17 wt %, about 16-19 wt %, about 18-21 wt %, about 20-23 wt %, about 0.1-23 wt %, about 22-25 wt %, about 24-27 wt %, about 26-29 wt %, about 28-31 wt %, about 30-33 wt %, about 32-35 wt %, about 20-30 wt %, about 22-30 wt %, about 20-35 wt %, about 22-35 wt %, about 26-35 wt %, about 30-35 wt %, about 35-40 wt %, about 30-40 wt %, about 40-45 wt %, about 42-48 wt %, about 45-50 wt %, about 40-50 wt %, about 50-60 wt %, about 60-70 wt %, about 70-80 wt %, about 80-90 wt %, or about 90-100 wt %, of the total weight of the superhydrophobic composition, or any weight percentage in a range bounded by any of these values. Of particular interest are any of the above ranges that encompass one or more of the following weight percentages: about 15 wt %, about 17 wt %, about 19 wt %, about 20 wt %, about 21 wt %, about 23 wt %, about 26 wt %, about 29 wt %, about 30 wt %, about 31 wt %, about 39 wt %, about 43 wt %, about 45 wt %, about 54 wt %, about 59 wt %, and about 71 wt %.

In some embodiments, a lanthanum phosphate nanoparticle, such as a lanthanum phosphate nanorod or nanowire may be about 0.1-10 wt %, about 10-20 wt %, about 10-13 wt %, about 12-15 wt %, about 14-17 wt %, about 16-19 wt %, about 18-21 wt %, about 20-23 wt %, about 0.1-23 wt %, about 22-25 wt %, about 24-27 wt %, about 26-29 wt %, about 28-31 wt %, about 30-33 wt %, about 32-35 wt %, about 20-30 wt %, about 22-30 wt %, about 20-35 wt %, about 22-35 wt %, about 26-35 wt %, about 30-35 wt %, about 35-40 wt %, about 30-40 wt %, about 40-45 wt %, about 42-48 wt %, about 45-50 wt %, about 40-50 wt %, about 50-60 wt %, about 60-70 wt %, about 70-80 wt %, about 80-90 wt %, or about 90-100 wt %, of the total weight of the superhydrophobic composition, or any weight percentage in a range bounded by any of these values. Of particular interest are any of the above ranges that encompass one or more of the following weight percentages: about 15 wt %, about 17 wt %, about 19 wt %, about 20 wt %, about 21 wt %, about 23 wt %, about 26 wt %, about 29 wt %, about 30 wt %, about 31 wt %, about 39 wt %, about 43 wt %, about 45 wt %, about 54 wt %, about 59 wt %, and about 71 wt %.

In some embodiments, an aluminum oxide nanoparticle (including a carboxylic acid, e.g. isostearic acid, modified aluminum oxide nanoparticle, such as an aluminum oxide nanorod or a nanowire, may be 0.1-10 wt %, about 10-20 wt %, about 10-13 wt %, about 12-15 wt %, about 14-17 wt %, about 16-19 wt %, about 18-21 wt %, about 20-23 wt %, about 0.1-23 wt %, about 22-25 wt %, about 24-27 wt %, about 26-29 wt %, about 28-31 wt %, about 30-33 wt %, about 32-35 wt %, about 20-30 wt %, about 22-30 wt %, about 20-35 wt %, or about 22-35 wt %, of the total weight of the superhydrophobic composition, or any weight percentage in a range bounded by any of these values. Of particular interest are any of the above ranges that encompass one or more of the following weight percentages: about 13 wt %, about 15 wt %, about 26 wt %, and about 29 wt %.

In some embodiments, the nanorods can have a substantially uniform distribution within the superhydrophobic composition. In some embodiments, no more than 20% of the nanorods have an area concentration that is more than twice the standard deviation of concentration for the composite. The distribution of the nanorods in turn is thought to result in a composite having exposed surfaces that define a nano-structure roughness with a scale commensurate with the dimensions of the nanorods; even after ablation of the initial surface. It is further thought that the nanostructure-scale roughness when combined with the hydrophobic character of the other materials in the composite result in a superhydrophobic composition that retains the superhydrophobicity even after the initial surface is eroded away.

A superhydrophobic composition may include optional additives, such as particulate additives. In some embodiments, the particulate additives can comprise particles silica, glass, and/or polymers such as fluorocarbons, e.g. polytetrafluoroethylene (Teflon). In some embodiments, the particles can be spherical. In some embodiments, the average or median diameter of a particulate additive can be in a range of about 0.1-3 μm, about 1-4 μm, about 2-5 μm, about 3-6 μm, about 4-7 μm, about 5-8 μm, about 6-9 μm, about 7-10 μm, about 0.1-20 μm, about 5-10 μm, about 10-15 μm, or about 15-20 μm, 0.5-50 μm, about 1-35 μm, or about 1-3.5 μm, about 1-15 μm, about 13-45 μm, about 50 nm to 12 μm, or about 35 μm. In some embodiments, a particulate additive has an average or median diameter that is at least 2, at least 5, at least 7, or at least 10 times that of the average or median diameter of the silica nanoparticles.

For superhydrophobic compositions using SiO₂ microparticles as an additive, the size of the microparticle is typically larger than that of the silica nanoparticle. Typically, the nanoparticles are nanometer sized to create nano sized roughness. The SiO₂ microparticle additives are micro sized to create micro size roughness. For example, the SiO₂ microparticle may have a diameter, such as an average or a median diameter, that is at least 2, at least 5, at least 7, or at least 10 times that of the average or median diameter of the silica nanoparticles. In some embodiments, the SiO₂ microparticle has a diameter, such as an average or a median diameter, of about 0.1-3 μm, about 1-4 μm, about 2-5 μm, about 3-6 μm, about 4-7 μm, about 5-8 μm, about 6-9 μm, about 7-10 μm, about 0.1-20 μm, about 5-10 μm, about 10-15 μm, or about 15-20 μm, or any diameter in a range bounded by any of these values. Of particular interest are any of the above ranges that encompass or overlap with the range 1-3.5 μm. In some embodiments, the SiO₂ microparticles are spherical.

In some embodiments, SiO₂ microparticles may be about 0.5-1.5 wt %, about 1-2 wt %, about 1.5-2.5 wt %, about 2-3 wt %, about 2.5-3.5 wt %, about 3-4 wt %, about 3.5-4.5 wt %, about 4-5 wt %, about 4-8 wt %, about 6-10 wt %, about 8-12 wt %, about 10-14 wt %, about 12-17 wt %, about 15-20 wt %, or about 18-23 wt % of the total weight of the superhydrophobic composition, or any weight percentage in a range bounded by any of these values. Of particular interest are any of the above ranges that encompass one or more of the following weight percentages: about 0.9%, about 1.3%, about 10%, and about 18%.

For superhydrophobic compositions using glass microparticles as an additive, the size of the microparticle is typically larger than that of the silica nanoparticle. For example, the glass microparticle may have a diameter, such as an average or a median diameter, that is at least 2, at least 5, at least 7, or at least 10 times that of the average or median diameter of the silica nanoparticles. In some embodiments, the glass microparticle has a diameter, such as an average or a median diameter, of about 3-8 μm, about 6-11 μm, about 9-14 μm, about 12-17 μm, about 15-20 μm, about 18-23 μm, about 21-26 μm, about 24-29 μm, about 27-32 μm, about 30-35 μm, about 33-38 μm, about 36-41 μm, about 39-44 μm, about 42-47 μm, or about 45-50 μm, or any diameter in a range bounded by any of these values. Of particular interest are any of the above ranges that encompass or overlap with the ranges 1-15 μm, 13-45 μm. In some embodiments, the glass microparticle is spherical.

In some embodiments, SiO₂ microparticles may be about 0.5-1.5 wt %, about 1-2 wt %, about 1.5-2.5 wt %, about 2-3 wt %, about 2.5-3.5 wt %, about 3-4 wt %, about 3.5-4.5 wt %, about 4-5 wt %, about 4-8 wt %, about 6-10 wt %, about 8-12 wt %, about 10-14 wt %, about 12-17 wt %, about 15-20 wt %, or about 18-23 wt % of the total weight of the superhydrophobic composition, or any weight percentage in a range bounded by any of these values. Of particular interest are any of the above ranges that encompass one or more of the following weight percentages: about 0.9%, about 1.3%, about 10%, and about 18%.

For superhydrophobic compositions using polytetrafluoroethylene microparticles as an additive, the size of the microparticle is typically larger than that of the silica nanoparticle. For example, the polytetrafluoroethylene microparticle may have a diameter, such as an average or a median diameter, that is at least 2, at least 5, at least 7, or at least 10 times that of the average or median diameter of the silica nanoparticles. In some embodiments, the polytetrafluoroethylene has a diameter, such as an average or a median diameter, of about 3-8 μm, about 6-11 μm, about 9-14 μm, about 12-17 μm, about 15-20 μm, about 18-23 μm, about 21-26 μm, about 24-29 μm, about 27-32 μm, about 30-35 μm, or about 33-38 μm, or any diameter in a range bounded by any of these values. Of particular interest are any of the above ranges that encompass or overlap with the ranges less than 12 μm, 35 μm. In some embodiments, the polytetrafluoroethylene is spherical.

In some embodiments, polytetrafluoroethylene microparticles may be about 0.5-1.5 wt %, about 1-2 wt %, about 1.5-2.5 wt %, about 2-3 wt %, about 2.5-3.5 wt %, about 3-4 wt %, about 3.5-4.5 wt %, about 4-5 wt %, about 4-8 wt %, about 6-10 wt %, about 8-12 wt %, about 10-14 wt %, about 12-17 wt %, about 15-20 wt %, or about 18-23 wt % of the total weight of the superhydrophobic composition, or any weight percentage in a range bounded by any of these values. Of particular interest are any of the above ranges that encompass about 0.9%.

A superhydrophobic composition may be in the form of a solid layer on a surface where it may be undesirable for ice, water, or snow to accumulate. In some embodiments, the superhydrophobic composition is a solid layer with a thickness of about 16-20 μm, about 18-22 μm, about 20-24 μm, about 22-26 μm, about 24-28 μm, about 26-30 μm, about 28-32 μm, about 30-34 μm, about 32-36 μm, about 34-38 μm, about 36-40 μm, about 38-42 μm, about 40-44 μm, about 42-46 μm, about 44-48 μm, about 46-50 μm, about 45-52 μm, about 50-57 μm, about 55-62 μm, about 60-67 μm, about 65-72 μm, about 70-77 μm, about 75-82 μm, about 80-87 μm, about 85-92 μm, about 90-97 μm, about 95-102 μm, about 100-107 μm, about 105-112 μm, about 110-117 μm, about 115-122 μm, about 120-127 μm, or about 125-132 μm, or any thickness in a range bounded by any of these values. Of particular interest are any of the above ranges that encompass one or more of the following thicknesses: about 22 μm, about 23 μm, about 27 μm, about 30 μm, about 33 μm, about 35 μm, about 46 μm, about 79 μm, and about 106 μm.

A superhydrophobic composition may be used in a surface treatment for repelling ice, water, or snow from a surface. The method can comprise treating a surface with a mixture comprising a hydrophobic polymer, silica nanoparticles, and metal compound nanoparticles.

For treating a surface, a superhydrophobic composition may be mixed in a solvent to form a coating mixture. Such a mixture can comprise the requisite amounts of hydrophobic polymer, silica nanoparticles, metal compound nanoparticles, and the solvent, such as toluene, tetrachloroethane, acetone, or any combination thereof. In some embodiments, the treatment comprises: (1) mixing hydrophobic polymer, silica nanoparticles, and metal compound nanoparticles with a solvent to create a mixture, (2) applying the mixture on the untreated surface, and (3) curing the coating by heating the coating to a temperature between 40° C. to 150° C. for 30 minutes to 3 hours, to completely evaporate the solvent.

Metal compound nanoparticles may be modified with carboxylic acids by exposing and/or reacting the metal compound nanoparticles with a C₁₄₋₂₀ alkyl acid, e.g., isostearic acid. This may cause the carboxylic acid to be linked, covalently bonded, or substituted upon the surface of the metal compound nanoparticles. In some methods, mixing the metal compound nanoparticles can comprise mixing lanthanum (III) phosphate nanorods and/or isostearic modified acid-modified aluminum (III) oxide nanorods. In some embodiments, mixing the hydrophobic polymer can comprise mixing PDMS or a polycarbonate. In some embodiments, mixing can further comprise mixing in nanoparticles with an average diameter of about 500 nm to about 50 μm, where the nanoparticles comprise polytetrafluoroethylene (Teflon), glass, or silica.

In some embodiments, the step of treating can also comprise the intermediate steps of drying, crushing, and reconstituting the mixture after mixing but before applying the mixture. It is believed that the intermediate steps will ensure uniform mixing and prevent lumps in the coating. In some the intermediate steps, where the mixture is first suspended in a solvent, the solvent can be evaporated by methods known to those skilled in the art to create a dried powder. In some methods, then the dried powder can be subsequently crushed by methods known in the art, such as a mortar and pestle, to break up any lumps. In some crushing steps, a solvent, such as acetone, may be added to help break up lumps and facilitate a smooth mixture. In some methods the intermediate step of crushing and drying can then comprise drying the smooth mixture at a temperature of about 40° C. to about 100° C., or about 90° C., until completely dry.

In some embodiments the treating step can also comprise applying the coating mixture on the untreated surface. Applying the coating mixture can be done by any methods known by those skilled in the art, such as blade coating, spin coating, dye coating, physical vapor deposition, chemical vapor deposition, spray coating, ink jet coating, roller coating, etc. In some embodiments, the coating step can be repeated until the desired thickness of coating is achieved. In some methods, applying can be done such that a contiguous layer is formed on the surface to be protected.

In some embodiments, the wet coating of superhydrophobic composition may have a thickness of about 1-50 μm, about 10-30 μm, about 20-30 μm, about 50-150 μm, about 100-200 μm, about 150-250 μm, about 200-300 μm, about 260-310 μm, about 280-330 μm, about 300-350 μm, about 320-370 μm, about 340-390 μm, about 360-410 μm, about 380-430 μm, about 400-450 μm, about 420-470 μm, about 400-600 μm, about 500-700 μm, or about 600-800 μm or any thickness in a range bounded by any of these values. Of particular interest are any of the above ranges that encompass one or more of the following thicknesses: about 25 μm, about 300 μm, about 350 μm, about 380 μm, and about 790 μm.

In some embodiments, treating can further comprise curing the coating by heating the coating to a temperature and time sufficient to completely evaporate the solvent. In some embodiments, the step of curing can be done at a temperature of about 40° C. to about 150° C., or about 120° C., for about 30 minutes to 3 hours, or about 1-2 hours, until the solvent is completely evaporated. In some embodiments, a composition by the process described above can be provided. The result can be a treated surface that can be resistant to water or ice even after facing a harsh environment where some of the coating has been eroded.

The following embodiments are specifically contemplated:

Embodiment 1. A superhydrophobic composition comprising: a hydrophobic polymer; silica nanoparticles; and metal compound nanoparticles with an aspect ratio of about 5 to about 10,000; wherein the composite has bulk superhydrophobic properties.
Embodiment 1A. The superhydrophobic composition of embodiment 1, which is in a solid form.
Embodiment 2. The superhydrophobic composition of embodiment 1 or 1A, wherein the hydrophobic polymer comprises a polysiloxane or a polycarbonate.
Embodiment 3. The superhydrophobic composition of embodiment 2, wherein the polysiloxane comprises polydimethylsiloxane.
Embodiment 4. The superhydrophobic composition of embodiment 2, wherein the hydrophobic polymer comprises a combination of a polycarbonate and polydimethylsiloxane.
Embodiment 5. The superhydrophobic composition of embodiment 1, 2, 3, or 4, wherein the metal compound nanoparticles comprise a phosphate salt of a rare earth metal or a metal oxide.
Embodiment 6. The superhydrophobic composition of embodiment 5, wherein the phosphate salt comprises a lanthanum (III) phosphate.
Embodiment 7. The superhydrophobic composition of embodiment 6, wherein the lanthanum (III) phosphate is in the form of nanorods with a length of 0.1 μm to 5 μm and a width or a diameter of 10 nm to 100 nm.
Embodiment 8. The superhydrophobic composition of embodiment 5, wherein the metal oxide comprises a carboxylic acid-modified aluminum (III) oxide.
Embodiment 9. The superhydrophobic composition of embodiment 8, wherein the acid-modified aluminum (III) oxide is in the form of nanorods with a length of 10 μm to 150 μm and a width or a diameter of 2 nm to 30 nm.
Embodiment 10. The superhydrophobic composition of embodiment 8, wherein the acid-modified aluminum (III) oxide is formed by reacting an aluminum (III) oxide with isostearic acid.
Embodiment 11. The superhydrophobic composition of embodiment 1, further comprising microparticles with an average diameter of 500 nm to 50 μm.
Embodiment 12. The superhydrophobic composition of embodiment 11, wherein the microparticles comprise microparticles of polytetrafluoroethylene (Teflon), glass, or silica.
Embodiment 13. A method of surface treatment comprising treating an untreated surface with a composition comprising a hydrophobic polymer, silica nanoparticles, and metal compound nanoparticles.
Embodiment 14. The method of embodiment 13, wherein the step of the surface treatment comprises: (1) mixing hydrophobic polymer, silica nanoparticles, and metal compound nanoparticles with a solvent to create a mixture, (2) applying the mixture on the untreated surface to create a coating, and (3) curing the coating by heating the coating to a temperature between about 40° C. to about 150° C. for 30 minutes to 3 hours, to completely evaporate the solvent.
Embodiment 15. The method of embodiment 14, wherein the step of mixing hydrophobic polymer, silica nanoparticles, and metal compound nanoparticles with a solvent to create a mixture, further comprises treating the metal compound nanoparticles with isostearic acid.
Embodiment 16 The method of embodiment 14, wherein mixing the nanocomposite nanorods comprises mixing lanthanum (III) phosphate nanorods or isostearic acid-modified aluminum (III) oxide nanorods.
Embodiment 17. The method of embodiment 14, wherein mixing the hydrophobic polymer comprises mixing polydimethylsiloxane and polycarbonate.
Embodiment 18. The method of embodiment 14, wherein mixing further comprises mixing in microparticles with an average diameter of 500 nm to 50 μm, wherein the nanoparticles comprise polytetrafluoroethylene (Teflon), glass, or silica.

### EXAMPLES

It has been discovered that embodiments of the superhydrophobic compositions described herein exhibit bulk performance. These benefits are further demonstrated by the following examples, which are intended to be illustrative of the disclosure, but are not intended to limit the scope or underlying principles in any way.

### Example 1.1.1: Preparation of LaPO₄ Nanorods

Preparation of the LaPO₄ Nanorods:

The LaPO₄ nano rods were synthesized through hydrothermal reaction between La(NO₃)₃ and (NH₄)₂HPO₄ in a high pressure reactor. First, Lanthanum(III) nitrate hexahydrate (La(NO₃)₃) (12.99 g, 30 mmol, Sigma-Aldrich Corporation, St. Louis, Mo. USA), ammonium phosphate dibasic ((NH₄)₂HPO₄) (3.96 g, 30 mmol, Aldrich) and water (10 mL, Milli-Q, EMD Millipore, Billerica, Mass.) were put in an inner Teflon vessel of a reaction vessel assembly (Columbia International Tech., Irmo, S.C. USA) with a stirrer bar and then sealed completely inside the assembly's outer stainless steel vessel. The reactor vessel assembly was then immersed in silicone oil (Aldrich) at room temperature and the temperature was increased to 130° C. and held there for 32 hours while continuously stirring. The reactor was then left to cool to room temperature and the contents removed. In the preceding reaction the byproduct of nitric acid is formed, so the pH of supernatant is good indicator to see the quality or the wash, or how much nitric acid is removed. The obtained slurry was then washed with DI water repeatedly through centrifugation (IEC Centra CL2, Thermo Fisher Scientific, Waltham, Mass. USA) at 2500 rpm for 15 minutes until pH of supernatant water was in the range of 6-7, and then washed with acetone (Aldrich) repeatedly through centrifugation (IEC Centra CL2, Thermo Fisher) at 2500 rpm for 15 minutes. The slurry was then dried in 75° C. oven (105 L Symphony Gravity Convection Oven, VWR International, Visalia, Calif. USA) overnight. The dried powder was then placed in a quartz crucible (CGQ-4000-04, Chemglass Life Sciences, Vineland, N.J. USA) and annealed at 450° C. for 5 hours in a muffle furnace (Type 1300, Barnstead/Thermolyne Corporation, Dubuque, Iowa USA) to result in the LaPO₄ nanorods.

### Example 1.1.2: Preparation of Al₂O₃ Modified Nanorods

Modification of the Al₂O₃ Nanorods:

First, aluminum (III) oxide nanofibers (3 g, dia. 20 nm×len. 100 μm, 790915-25G; Aldrich) were dispersed in toluene (50 mL, anhydrous, 98%, Aldrich) and sonicated for 15 minutes. The resulting dispersion was then added to a mixture of isostearic acid (134 mL, 120 g; Aldrich) and toluene (50 mL, anhydrous; Aldrich). The resulting mixture was then heated while stirring in a silicone oil bath to 115° C. for 4 days. After cooling to room temperature, the resulting solid was washed with acetone through centrifugation (3000 rpm for 5 minutes). The washed solid was then dried at 70° C. overnight to result in modified Al₂O₃ nanorods.

### Example 1.2.1: Preparation of Coating Mixture

Preparation Coating Slurry:

First a polydimethylsiloxane (PDMS) resin (0.4 g, Sylgard 184, Dow-Corning Corporation, Midland, Mich. USA) was dissolved in a mixture of toluene and tetrachloroethane (80 mL, 1:1 vol., Aldrich). Then, silica nanoparticles (20 nm, Sky Spring Nanomaterials, Inc., Houston, Tex. USA) were stirred into the mixture. Next, 1.0 g of LaPO₄ nanorods were added to the mixture. The resulting mixture was then sonicated and stirred until the nanorods were well dispersed. Next, the polymer binder polycarbonate was added and the mixture was then stirred at room temperature until completely dissolved, about 2-3 hours. Next, the solvent was then completely evaporated using a rotary evaporator (R-215 Rotavapor, Buchi Corporation, New Castle, Del. USA). The resulting solid was then ground with a mortar and pestle to make a fine powder, adding acetone (Aldrich) to break up lumps. The resulting powder was then dried at 90° C. in a vacuum until completely dry. The resulting powder was then dissolved in toluene (Aldrich) to create a 20 wt % solution in toluene.

### Example 2.1.1: Preparation of a Superhydrophobic Coating Element

Coating Application.

The slurry was cast on a PET film (7.5 cm×30 cm) with a Casting Knife Film applicator (Microm II Film Applicator, Paul N. Gardner Company, Inc.) at a cast rate of 10 cm/s. The blade gap on the film applicator was set at about 100-350 μm (127 μm-300 μm) (5-15 mil). For applications wider than about 2 inches/5.1 cm, an adjustable film applicator (AP-B5351, Paul N. Gardner Company, Inc., Pompano Beach, Fla., USA) was alternatively used.

Drying:

The coating was then dried overnight at 120° C. inside an air-circulating oven (105 L Symphony Gravity Convection Oven, VWR) until completely dry, about 1-2 hours, to produce the treated substrate, or Element 1 (E-1).

### Example 2.1.1.1: Preparation of Additional Elements

Additional coatings were constructed using the methods similar to Example 1.2.1 and Example 2.1.1, with the exception that parameters were varied for the as shown in Table 1. Where additives were specified, they were mixed into the coating slurry along with the other materials. The wet thickness was the coating thickness set by the coating instruments, dry thickness was the thickness of the coating as measured near the coating edge. For embodiments, without a dry thickness, the dry thickness is planned to be measured.

For additional embodiments, the materials were the following: polycarbonate (PC) (APEC1803, Convestro AG, Leverkusen, Germany), polystyrene (PS) (Aldrich), Poly n-butyl methacrylate (PnM) (Polysciences, Inc., Warrington, Pa. USA), non-modified aluminum oxide nanofibers (<20 nm×100 μm, Aldrich), SiO₂ spheres (1-3.5 μm, Lot 4855-071613, Nanoamorphous Materials, Los Alamos, N. Mex. USA), glass spheres (Novum Glass LLC, Rolla, Mo. USA), polytetrafluoroethylene (Teflon) particles (Aldrich). For the additional embodiments, where spray coating was indicated the mixture was sprayed on the surface using conventional methods.

TABLE 1
Superhydrophobic Elements.

| | Weight Percentages (wt %) | | | | | | | | | | | | | |
|---|---|---|---|---|---|---|---|---|---|---|---|---|---|---|
| | | | | | | | | SiO₂ | Glass | Teflon | Slurry | | | |
| | | | Al₂O₃ | | | | | Sph./ | Sph./ | Sph./ | wt % | Appl. | Thickness (μm) | |
| Element | F—SiO₂ | LaPO₄ | (M/NM) | PDMS | PC | PS | PnM | Dia | Dia | Dia | in Sol. | Type | Wet | Dry |
| E-1.1 | 29.4 | 29.4 | — | 11.8 | 29.4 | — | — | — | — | — | 20 | Cast | 380 | 46 |
| E-1.2 | 29.4 | 29.4 | — | 11.8 | 29.4 | — | — | — | — | — | 20 | Cast | 790 | 106 |
| E-1.3 | 29.4 | 29.4 | — | 11.8 | 29.4 | — | — | — | — | — | 20 | Cast | 300 | 35 |
| E-1.4 | 29.4 | 29.4 | — | 11.8 | 29.4 | — | — | — | — | — | 20 | Cast | 350 | 33 |
| E-1.5 | 25.6 | 25.6 | — | 10.3 | 38.5 | — | — | — | — | — | 20 | Cast | 300 | 22 |
| E-1.6 | 25.6 | 25.6 | — | 10.3 | 38.5 | — | — | — | — | — | 20 | Cast | 350 | 23 |
| E-1.7 | 22.7 | 22.7 | — | 9.1 | 45.5 | — | — | — | — | — | 20 | Cast | 380 | 30 |
| E-1.8 | 22.7 | 22.7 | — | 9.1 | 45.5 | — | — | — | — | — | 20 | Cast | 790 | 79 |
| E-1.9 | 22.7 | 22.7 | — | 9.1 | 45.5 | — | — | — | — | — | 20 | Cast | 300 | 35 |
| E-1.10 | 22.7 | 22.7 | — | 9.1 | 45.5 | — | — | — | — | — | 20 | Cast | 350 | 27 |
| E-2.1 | — | 58.82 | — | 11.76 | 29.41 | — | — | — | — | — | 25 | Cast | 25 | — |
| E-2.2 | 19.71 | 39.12 | — | 11.76 | 29.41 | — | — | — | — | — | 25 | Cast | 25 | — |
| E-2.3 | 29.41 | 29.41 | — | 11.76 | 29.41 | — | — | — | — | — | 25 | Cast | 25 | — |
| E-2.4 | 39.12 | 19.71 | — | 11.76 | 29.41 | — | — | — | — | — | 25 | Cast | 25 | — |
| E-2.5 | 58.82 | — | — | 11.76 | 29.41 | — | — | — | — | — | 25 | Cast | 25 | — |
| E-2.6 | — | 45.45 | — | 9.09 | 45.45 | — | — | — | — | — | 25 | Cast | 25 | — |
| E-2.7 | 15.23 | 30.23 | — | 9.09 | 45.45 | — | — | — | — | — | 25 | Cast | 25 | — |
| E-2.8 | 22.73 | 22.73 | — | 9.09 | 45.45 | — | — | — | — | — | 25 | Cast | 25 | — |
| E-2.9 | 30.23 | 15.23 | — | 9.09 | 45.45 | — | — | — | — | — | 25 | Cast | 25 | — |
| E-2.10 | 45.45 | 0.00 | — | 9.09 | 45.45 | — | — | — | — | — | 25 | Cast | 25 | — |
| E-2.11 | 29.41 | 29.41 | — | 20.59 | 20.59 | — | — | — | — | — | 25 | Cast | 25 | — |
| E-2.12 | 29.41 | 29.41 | — | 29.41 | 11.76 | — | — | — | — | — | 25 | Cast | 25 | — |
| E-2.13 | 25.64 | 25.64 | — | 10.26 | — | 38.46 | — | — | — | — | 25 | Cast | 25 | — |
| E-2.14 | 33.59 | 17.31 | — | 10.34 | — | 38.76 | — | — | — | — | 25 | Cast | 25 | — |
| E-2.15 | 29.41 | 29.41 | — | 11.76 | — | — | 29.41 | — | — | — | 25 | Cast | 25 | — |
| E-2.16 | 25.64 | 25.64 | — | 10.26 | — | — | 38.46 | — | — | — | 25 | Cast | 25 | — |
| E-3.1 | 0.00 | 58.82 | — | 11.76 | 29.41 | — | — | — | — | — | 15 | Cast | 25 | — |
| E-3.2 | 19.71 | 39.12 | — | 11.76 | 29.41 | — | — | — | — | — | 15 | Cast | 25 | — |
| E-3.3 | 29.41 | 29.41 | — | 11.76 | 29.41 | — | — | — | — | — | 15 | Cast | 25 | — |
| E-3.4 | 39.12 | 19.71 | — | 11.76 | 29.41 | — | — | — | — | — | 15 | Cast | 25 | — |
| E-3.5 | 58.82 | 0.00 | — | 11.76 | 29.41 | — | — | — | — | — | 15 | Cast | 25 | — |
| E-3.6 | 0.00 | 45.45 | — | 9.09 | 45.45 | — | — | — | — | — | 15 | Cast | 25 | — |
| E-3.7 | 15.23 | 30.23 | — | 9.09 | 45.45 | — | — | — | — | — | 15 | Cast | 25 | — |
| E-3.8 | 22.73 | 22.73 | — | 9.09 | 45.45 | — | — | — | — | — | 15 | Cast | 25 | — |
| E-3.9 | 30.23 | 15.23 | — | 9.09 | 45.45 | — | — | — | — | — | 15 | Cast | 25 | — |
| E-3.10 | 45.45 | 0.00 | — | 9.09 | 45.45 | — | — | — | — | — | 15 | Cast | 25 | — |
| E-3.11 | 29.41 | 29.41 | — | 20.59 | 20.59 | — | — | — | — | — | 15 | Cast | 25 | — |
| E-3.12 | 29.41 | 29.41 | — | 29.41 | 11.76 | — | — | — | — | — | 15 | Cast | 25 | — |
| E-3.13 | 25.64 | 25.64 | — | 10.26 | — | 38.46 | — | — | — | — | 15 | Cast | 25 | — |
| E-3.14 | 33.59 | 17.31 | — | 10.34 | — | 38.76 | — | — | — | — | 15 | Cast | 25 | — |
| E-3.15 | 29.41 | 29.41 | — | 11.76 | — | — | 29.41 | — | — | — | 15 | Cast | 25 | — |
| E-3.16 | 25.64 | 25.64 | — | 10.26 | — | — | 38.46 | — | — | — | 15 | Cast | 25 | — |
| E-4.1 | 29.41 | 29.41 | — | 11.76 | — | 29.41 | — | — | — | — | 25 | Cast | 25 | — |
| E-4.2 | 44.12 | 14.71 | — | 11.76 | — | 29.41 | — | — | — | — | 25 | Cast | 25 | — |
| E-4.3 | 58.82 | 0.00 | — | 11.76 | — | 29.41 | — | — | — | — | 25 | Cast | 25 | — |
| E-4.4 | 44.12 | 14.71 | — | 11.76 | — | — | 29.41 | — | — | — | 25 | Cast | 25 | — |
| E-4.5 | 58.82 | 0.00 | — | 11.76 | — | — | 29.41 | — | — | — | 25 | Cast | 25 | — |
| E-4.6 | 29.41 | 29.41 | — | 0.00 | — | — | 41.18 | — | — | — | 25 | Cast | 25 | — |
| E-5.1 | 29.41 | 29.41 | — | 11.76 | 29.41 | — | — | — | — | — | 10 | Spray | N/A | — |
| E-5.1 | 29.41 | 29.41 | — | 11.76 | 29.41 | — | — | — | — | — | 10 | Spray | N/A | — |
| E-5.1 | 29.41 | 29.41 | — | 11.76 | 29.41 | — | — | — | — | — | 10 | Spray | N/A | — |
| E-5.1 | 29.41 | 29.41 | — | 11.76 | 29.41 | — | — | — | — | — | 10 | Spray | N/A | — |
| E-5.1 | 29.41 | 29.41 | — | 11.76 | 29.41 | — | — | — | — | — | 10 | Spray | N/A | — |
| E-6.1 | 29.41 | — | 29.41 | 11.76 | 29.41 | — | — | — | — | — | 25 | Cast | 25 | — |
| | | | (M) | | | | | | | | | | | |
| E-6.2 | 44.12 | — | 14.71 | 11.76 | 29.41 | — | — | — | — | — | 25 | Cast | 25 | — |
| | | | (M) | | | | | | | | | | | |
| E-6.3 | 25.64 | — | 25.64 | 10.26 | 38.46 | — | — | — | — | — | 25 | Cast | 25 | — |
| | | | (M) | | | | | | | | | | | |
| E-6.4 | 38.46 | — | 12.82 | 10.26 | 38.46 | — | — | — | — | — | 25 | Cast | 25 | — |
| | | | (M) | | | | | | | | | | | |
| E-6.5 | 29.41 | — | 29.41 | 11.76 | 29.41 | — | — | — | — | — | 25 | Cast | 25 | — |
| | | | (NM) | | | | | | | | | | | |
| E-6.6 | 25.64 | — | 25.64 | 10.26 | 38.46 | — | — | — | — | — | 25 | Cast | 25 | — |
| | | | (NM) | | | | | | | | | | | |
| E-7.1 | 23.04 | 23.04 | — | 9.22 | — | — | 34.56 | 10.14/ | — | — | 25 | Cast | 25 | — |
| | | | | | | | | 1-3.5 um | | | | | | |
| E-7.2 | 20.92 | 20.92 | — | 8.37 | — | — | 31.38 | 18.41/ | — | — | 25 | Cast | 25 | — |
| | | | | | | | | 1-3.5 um | | | | | | |
| E-7.3 | 23.04 | 23.04 | — | 9.22 | — | — | 34.56 | — | 10.14/ | — | 25 | Cast | 25 | — |
| | | | | | | | | | 1-15 um | | | | | |
| E-7.4 | 23.04 | 23.04 | — | 9.22 | — | — | 34.56 | — | 10.14/ | — | 25 | Cast | 25 | — |
| | | | | | | | | | 13-45 um | | | | | |
| E-7.5 | 20.92 | 20.92 | — | 8.37 | — | — | 31.38 | — | 18.41/ | — | 25 | Cast | 25 | — |
| | | | | | | | | | 1-15 um | | | | | |
| E-8.1 | 20.92 | 20.92 | — | 8.37 | — | — | 31.38 | 0.88/ | — | — | 25 | Cast | 25 | — |
| | | | | | | | | 1-3.5 um | | | | | | |
| E-8.2 | 20.92 | 20.92 | — | 8.37 | — | — | 31.38 | — | 0.88/ | — | 25 | Cast | 25 | — |
| | | | | | | | | | 1-15 um | | | | | |
| E-8.3 | 19.16 | 19.16 | — | 7.66 | — | — | 28.74 | 1.32/ | — | — | 25 | Cast | 25 | — |
| | | | | | | | | 1-3.5 um | | | | | | |
| E-8.4 | 19.16 | 19.16 | — | 7.66 | — | — | 28.74 | — | 1.32/ | — | 25 | Cast | 25 | — |
| | | | | | | | | | 1-15 um | | | | | |
| E-8.5 | 20.92 | 20.92 | — | 8.37 | — | — | 31.38 | — | — | 0.88/ | 25 | Cast | 25 | — |
| | | | | | | | | | | <12 um | | | | |
| E-8.6 | 20.92 | 20.92 | — | 8.37 | — | — | 31.38 | — | — | 0.88/ | 25 | Cast | 25 | — |
| | | | | | | | | | | 35 um | | | | |
| E-9.1 | — | 70.83 | — | 8.33 | 20.83 | — | — | — | — | — | 25 | Cast | 25 | — |
| E-9.2 | 12.86 | 53.81 | — | 9.52 | 23.81 | — | — | — | — | — | 25 | Cast | 25 | — |
| E-9.3 | 20.77 | 43.33 | — | 10.26 | 25.64 | — | — | — | — | — | 25 | Cast | 25 | — |
| E-9.4 | 30.11 | 31.22 | — | 11.05 | 27.62 | — | — | — | — | — | 25 | Cast | 25 | — |
| E-9.5 | 53.80 | — | — | 13.20 | 33.00 | — | — | — | — | — | 25 | Cast | 25 | — |

### Example 3.1: Characterization of Selected Elements

SEM Analysis:

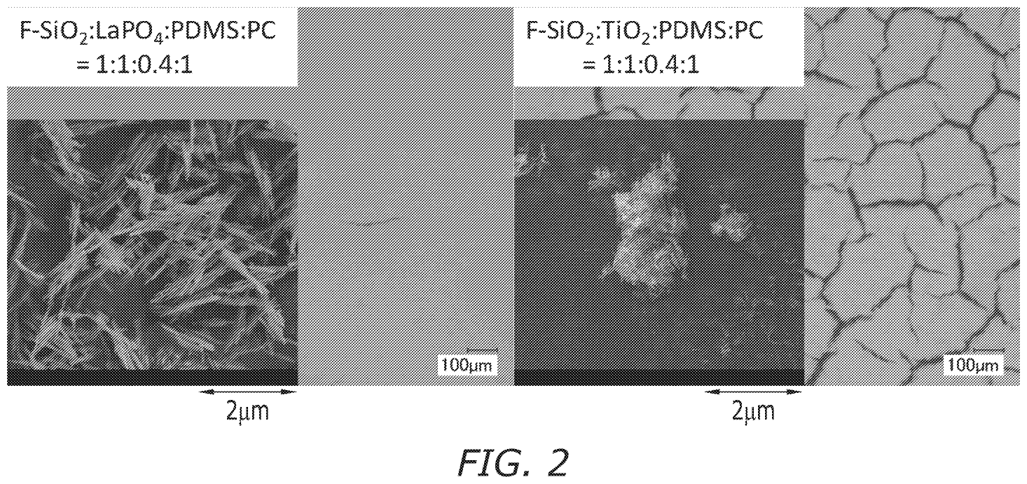

Element E-1.1 was analyzed with a Scanning Electron Microscope (SEM) and compared to an analogous element that had the lanthanum phosphate nanorods replaced with titanium dioxide nanoparticles. As shown in FIG. 2, element E-1.1 had significantly less cracking than the element with TiO₂. It is believed that reduction in cracking of the coating is due to the increased size of the LaPO₄ nanorods, 0.1 to 2.5 μm, which are on the whole significantly larger than the ^{˜}300 nm sized TiO₂ nanowires

### Example 3.1: Performance Testing of Selected Elements

Performance Testing:

The elements were cut into 1.3 cm×2.5 cm swatches and attached to a glass substrate for testing with double sided tape to form a measurement assembly. The contact angle of a drop of water was measured for the substrates and recorded. Next for each individual tape assemblies with substrates were tared on a balance (Mettler-Toledo AG, Greifensee, Switzerland). Then an abrasive surface, sand paper (600-grit silicon carbide, 3M St. Paul, Minn. USA) was rubbed against the sample keeping the pressure force between about 1.0-1.3 kg-f for about 100 times. About 5-8 μm of the composition had been ablated away. The test was repeated for different selected samples and at different abrasive characteristics as outlined in Table 2. In some measurements, the some abrasion tests were automated with the use of a surface abrasion tester (RT-300, Daiei Kagaku Seiki Manufacturing. Co., Ltd. Sakyo-Kukyoto, Japan). A comparative element using a commercial hydrophobic water repellent coating and primer (Hirec 100, NTT Advanced Technology Corporation, Kanagawa, Japan).

TABLE 2
Element Hydrophobicity Performance.

| | | Thick- | Contact Angle (°) | | | | |
|---|---|---|---|---|---|---|---|
| | Element | ness | | 1 | 10 | 100 | Type of Abrasion |
| # | Configuration | (μm) | Initial | Cycle | Cycles | Cycles | Test |
| E-1.1 | SiO₂:LaPO₄:PDMS:PC | 46 | 165 | — | — | 164 | Sandpaper: 600-grit, |
| | (1:1:0.4:1) | | | | | | 100 times; force: 1.0- |
| | | | | | | | 1.3 kg-f |
| E-1.3 | | 35 | 155 | — | 143 | 142 | Ball on Disk[2]: tip: |
| | | | | | | | SU2, 5 mm Φ; force: |
| | | | | | | | 0.5N (0.05 kg-f); |
| | | | | | | | speed: 30 mm/s |
| E-1.5 | SiO₂:LaPO₄:PDMS:PC | 22 | 150 | 158 | 155 | 156 | Sandpaper[1]: 1000- |
| | (1:1:0.4:1.5) | | | | | | grit, 100 times; force: |
| | | | | | | | 1.0-1.3 kg-f |
| | | 22 | 150 | 154 | 152 | 135 | Sandpaper[1]: 120- |
| | | | | | | | grit, 100 times; force: |
| | | | | | | | 1.0-1.3 kg-f |
| | | 22 | 150 | 143 | 131 | 121 | Cotton[1]: head (4 |
| | | | | | | | cm2); force: 5N (0.5 |
| | | | | | | | kg-f); speed 120 |
| | | | | | | | mm/s |
| E-1.7 | SiO₂:LaPO₄:PDMS:PC | 30 | 134 | — | — | 159 | Sandpaper: 600-grit, |
| | (1:1:0.4:2) | | | | | | 100 times; force: 1.0- |
| | | | | | | | 1.3 kg-f |
| E-1.9 | | 35 | 150 | — | 123 | 134 | Ball on Disk[2]: tip: |
| | | | | | | | SU2, 5 mm Φ; force: |
| | | | | | | | 0.5N (0.05 kg-f); |
| | | | | | | | speed: 30 mm/s |
| CE-1 | Hirec 100 | N/A | 151 | 133 | 123 | 123 | Cotton[1]: head (4 |
| | (Commercial) | | | | | | cm2); force: 5N (0.5 |
| | (CE-1) | | | | | | kg-f); speed 120 |
| | | | | | | | mm/s |

[1]Testing conducted using an automated surface abrasion tester.
[2]The ball on disk testing was conducted in an external laboratory setup.

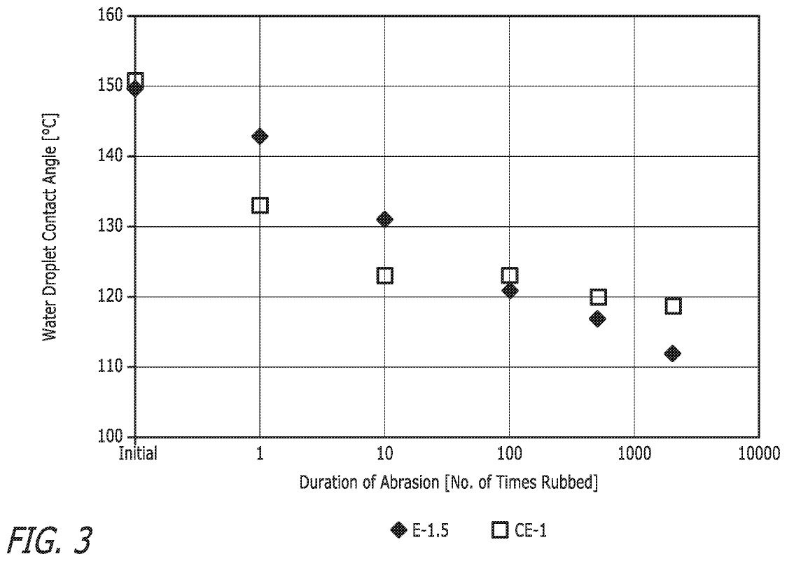

The results, shown in Table 2, indicate that when exposed to 600 grit sandpaper the elements initially exhibited superhydrophobicity and could maintain their superhydrophobicity. This is surprising given the fact that the LaPO₄ nanorods in powder form were only slightly hydrophobic. In some elements, such as E-1.5 with 600-grit sandpaper, the effect of the abrasion was to enhance the coating's superhydrophobicity. It was noticed that for wear with cotton, the overall hydrophobicity for the elements tested did slowly decrease as a function of number of intervals of wear. However, as shown in FIG. 3, E-1.5 outperformed CE-1 until about 100 wear internals indicating that for slight to moderate wear, E-1.5 performed better.

Additional tests are planned for selected embodiments where the elements will be subjected to artificial rain and/or snow conditions at various pitch angles ranging from 0 degrees (i.e., flat) to 45 degrees, including 15 degrees and 30 degrees. Then, the accumulation of water and/or snowfall versus angle is planned to be measured for selected samples to determine their durability in simulated environments. The environment in which the samples will be exposed is planned to have a temperature ranging from −10° C. to 0° C. to simulate winter conditions. In addition, wind speed of between 0 m/s to 15 m/s, including 5 m/s and 10 m/s will simulate storm conditions. Multiple types of snow accumulation are planned including the accumulation of flakes and/or the accumulation of graupel (e.g., sleet).

Unless otherwise indicated, all numbers expressing quantities of ingredients, properties such as molecular weight, reaction conditions, and etc. used in herein are to be understood as being modified in all instances by the term “about.” Each numerical parameter should at least be construed in light of the number of reported significant digits and by applying ordinary rounding techniques. Accordingly, unless indicated to the contrary, the numerical parameters may be modified according to the desired properties sought to be achieved, and should, therefore, be considered as part of the disclosure. At the very least, the examples shown herein are for illustration only, not as an attempt to limit the scope of the disclosure.

The terms “a,” “an,” “the” and similar referents used in the context of describing embodiments of the present disclosure (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illustrate embodiments of the present disclosure and does not pose a limitation on the scope of any claim. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the embodiments. Of course, variations on these described embodiments will become apparent to those of ordinary skill in the art upon reading the foregoing description. The inventor expects skilled artisans to employ such variations as appropriate, and the inventors intend for the embodiments of the present disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A superhydrophobic composition comprising: a hydrophobic polymer; silica nanoparticles; and metal compound nanoparticles; wherein the composition has bulk superhydrophobic properties.

2. The superhydrophobic composition of claim 1, which is in a solid form.

3. The superhydrophobic composition of claim 1, wherein the hydrophobic polymer comprises a polysiloxane or a polycarbonate.

4. The superhydrophobic composition of claim 3, wherein the polysiloxane comprises polydimethylsiloxane.

5. The superhydrophobic composition of claim 3, wherein the hydrophobic polymer comprises a mixture of a polycarbonate and polydimethylsiloxane.

6. The superhydrophobic composition of claim 1, wherein the metal compound nanoparticles comprise a phosphate salt of a rare earth metal or a metal oxide.

7. The superhydrophobic composition of claim 6, wherein the phosphate salt comprises a lanthanum (III) phosphate.

8. The superhydrophobic composition of claim 7, wherein the lanthanum (III) phosphate is in the form of nanorods with a length of 0.1 μm to 5 μm and a width or a diameter of 10 nm to 100 nm.

9. The superhydrophobic composition of claim 6, wherein the metal oxide comprises a carboxylic acid-modified aluminum (III) oxide.

10. The superhydrophobic composition of claim 9, wherein the acid-modified aluminum (III) oxide is in the form of nanorods with a length of 10 μm to 150 μm and a width or a diameter of 2 nm to 30 nm.

11. The superhydrophobic composition of claim 9, wherein the acid-modified aluminum (III) oxide is formed by reacting an aluminum (III) oxide with isostearic acid.

12. The superhydrophobic composition of claim 1, further comprising microparticles with an average diameter of 500 nm to 50 μm.

13. The superhydrophobic composition of claim 12, wherein the microparticles comprise microparticles of polytetrafluoroethylene, glass, or silica.

14. The superhydrophobic composition of claim 1, wherein the metal compound nanoparticles have an aspect ratio of about 5 to about 10,000.

15. A method of surface treatment comprising applying a superhydrophobic composition of claim 1, to a surface in need of treatment.

16. The method of claim 15, wherein the hydrophobic polymer, the silica nanoparticles, and the metal compound nanoparticles in the superhydrophobic composition are mixed with a solvent to create a mixture, the mixture is then applied to the surface, and the mixture that has been applied to the surface is heated at about 40° C. to about 150° C. for 30 minutes to 3 hours to completely evaporate the solvent.

17. The method of claim 16, wherein the hydrophobic polymer comprises a polysiloxane or a polycarbonate.

18. The method of claim 16, wherein the metal compound nanoparticles comprise lanthanum (III) phosphate or isostearic acid-modified aluminum (III) oxide.

19. The method of claim 16, wherein the mixture is applied to the surface by casting to form a layer that is about 20 μm to about 100 μm thick after the solvent is completely evaporated.

20. The method of claim 16, wherein a water droplet on the treated surface has a contact angle of greater than 150°.
